(19) United States
(12) Patent Application Publication
(10) Pub. No.: US 2022/0032099 A1
(43) Pub. Date: Feb. 3, 2022

(54) SPRINKLER TEST DEVICE AND METHOD

(71) Applicant: UNICA FIRE SAFETY B.V., Hoevelaken (NL)

(72) Inventor: Henk Jan KOOIJMANS, Hoevelaken (NL)

(73) Assignee: UNICA FIRE SAFETY B.V., Hoevelaken (NL)

(21) Appl. No.: 17/299,919

(22) PCT Filed: Dec. 4, 2019
(86) PCT No.: PCT/NL2019/050807

§ 371 Date: Jun. 4, 2021

(30) Foreign Application Priority Data
Dec. 5, 2018 (NL) 2022140

(51) Int. Cl. A62C 37/50; H04R 1/08

(52) U.S. Cl. CPC A62C 37/50; F24H 3/02; H04R 1/08

(57) ABSTRACT

The invention relates to a sprinkler test device comprising: a chamber configured to fit around a sprinkler head mounted in a sprinkler system; a drain conduit for guiding extinguishing agent to a disposal or collection container; a temperature regulator for regulating the temperature in the chamber. The invention further relates to a method for testing a sprinkler system, comprising the following steps, to be executed in any suitable order; providing a sprinkler test device as described herein above; positioning the chamber of the sprinkler test device around a first sprinkler head of a sprinkler system to be tested; and regulating the temperature around the sprinkler head for testing purposes.

The invention relates to a sprinkler test device and a method of in line testing of sprinkler systems.

More specifically, the invention relates to a sprinkler test device for fuse type operated sprinkler heads in the sprinkler system. Fuse type operated sprinkler heads are used to extinguish a fire below the sprinkler head. The functioning is basically as follows: the temperature of a fire heats up the room and as such the in the room present sprinkler heads. The sprinkler heads are provided with a cap, which blocks the outlet nozzle of the sprinkler head. The cap is hold in place by a fuse, which bursts, melts or ruptures at a specific predetermined temperature.

After bursting of the fuse, the cap is no longer held in place and the water pressure in the system urges water, or any other extinguishing agent out of the nozzle of the sprinkler head, thus extinguishing the fire below the sprinkler head.

These sprinkler heads can be directed downwards and are mounted or placed at ceilings or at higher positions, such that the extinguishing agent, after activation of the sprinkler head in question, pours down on the fire below the sprinkler head, which fire actually activated the sprinkler head by its heat melting or rupturing the sprinkler head fuse. The sprinkler heads can also be directed side wards or upwards.

Typically as for example in the Netherlands, users of a building need to be reassured that the building in which the users work or reside are safe. The question, when a building is safe varies a lot since the shape, dimensions and intensity of use of every building is different. The legal requirements and the insuring companies demand stricter and stricter testing of the safety systems available within the buildings in question. Parameters to be take into account are, the total usable area of the building, the height of the various spaces within the building, the functioning of the building, like is it used in industrial production, health care, office space or sports facility.

In some of these building a sprinkler system is integrated in the building, for example to separate the building into fire containing compartments or because an insuring company so requires. If a sprinkler installation is provided in a building, the owner of the building needs to comply with the various legal requirements governing the maintenance and inspection of the sprinkler system. These legal requirements are provided for securing that the installations are maintained and inspected adequately such that it can be relied upon that the installation functions properly and adequately when it is necessary e.g. when indeed a fire is spreading within the building. Sprinkler systems for fire protection are in fact dormant systems, normally inactive for most of the time. Without a periodic test performed regularly, the first test would be at an actual fire incident. This is for obvious reasons not the best way of testing.

Regulations governing e.g. the maintenance and testing of sprinkler installations are integrated in the international standards like: UL, NFPA, FM, VdS and/or CEN.

One of the requirements of various standards is that sprinkler heads need to be replaced on a regular basis. At which time intervals this replacement should take place, depends on the division of the specific type of sprinkler heads according to the various standards.

As alternative for the entire replacement of all sprinkler heads, a test for the adequate functioning may be performed by a random and representative sample. In this sample some heads are dismounted from the system and send to a recognised testing facility such as UL, FM or VdS for standardised testing. During such tests, the fuses, generally glass bulbs containing a low boiling liquid are gradually heated and it is measured after which time and at which temperature the fuse actually activates, i.e. ruptures or melts. If the fuses activate within the required time at the required temperature, the set of sprinklers is approved and a replacement of all the sprinklers in the system can be officially be dispensed with.

If on the contrary one of the fuses refuses to be activated at the required parameters, all sprinkler heads in the system need to be replaced, or a bigger sample from the same system is required to redo the test.

These tests are highly representative for the functioning state of the sprinkler heads. On the basis of the sample test a reliable estimation can be made about when, after which time and at which temperature, the sprinkler heads within a system will be activated.

A sprinkler system is however a complex system which comprises many more components than the sprinkler heads only. If the sprinkler heads and the fuses function well and properly, this alone will however not guarantee that the system actually is working, e.g. that actually water in sufficient and adequate quantities will exit the sprinkler head in question. The conduits may be blocked or corrosion scaling may have collected in the sprinkler heads in question, blocking the outpour of water.

A further important issue in the sprinkler system is, if the water pump will be activated at the activation of a sprinkler head. In other words, it can be that the sprinkler heads fulfil all requirements, while the system as such malfunctions. A proper, more holistic way of testing is there for required.

In the art, some kind of systems for testing sprinkler systems have been proposed: The American patent application US 2018236286 discloses a test device to measure the volume flow of a sprinkler head by using a collection container. This application does however not test the actual accuracy of the temperature at which the fuse melts and the sprinkler head opens up.

The American patent application US 2016054158A1 discloses a testing method in which a gas flow is used to measure the flow in an open type of sprinkler system. Here the gas flow is measured at the individual heads of the open sprinkler system. This system is however not suitable for use in fuse type of closed sprinkler systems.

Accordingly it is an object of the invention to mitigate or solve the above described and/or other problems of sprinkler test systems in the art, while maintaining and/or improving the advantages thereof.

More specifically the object of the invention can be seen in providing a sprinkler test system, that can test in situ, in the sprinkler system itself the functionality of the system, wherein the actual set temperature of the fuse is tested, together with the actual flow of extinguishing agent at the specific location of the sprinkler head.

Such a test system measures the performance of the entire system, i.e. the sufficient amount of agent, the activation temperature of the fuse, the openness of the conduits from the extinguishing agent source up to the actual nozzle of the sprinkler head.

These and/or other objects are reached by a sprinkler test device according to the invention, comprising a chamber configured to fit around a sprinkler head mounted in a sprinkler system; a drain conduit for guiding extinguishing agent to a disposal or collection container; and a temperature regulator for regulating the temperature in the chamber.

By these measures, the temperature in the chamber can be controlled and for instance provided with a time dependant regime of slowly rising temperature, such that the activation temperature can be determined exactly. Further advantages of such test system are that it provides a real life test, which is by its holistic nature more reliable than currently prescribed lab tests, where only parts of the system are tested. Any further issues with the sprinkler system to be tested can be identified in one test, such as the pump performance, the activation of the pump, blockages in the conduits, and in the spray heads. Furthermore, the signalling of an alarm to eventual third party services may be checked as well. A further advantage is, that no parts need to be send to any external laboratory for testing.

By this system relative low amounts of water need to be used for testing and the water after exiting the extinguishing system will remain contained within the test system.

During testing, the conduits can be inspected by e.g. boroscope inspection, because the conduits are accessible after the test anyhow. This may further provide an even more complete picture of the sprinkler system in question.

Thus a field test, in the location of the sprinkler head can be performed, where the flow of water can be measured after activation of the sprinkler head, such that not only the temperature but also the performance of the system, once activated can be measured. This provides an elegant integration of required measurements and tests in one complete system, which is relative easy to operate, robust and reliable, while the costs of testing are kept within relative reasonable boundaries.

For proper testing, the temperature regulator may comprise a temperature sensor, which is arranged preferably in the chamber. This sensor can monitor the actual temperature in the chamber and can further be used as a feed back for the controller in order to control the temperature as exactly as possible. Thus a very accurate temperature of activation, i.e. the burst or melting of the fuse of the sprinkler head in question can be obtained.

In order to control the temperature in the chamber, the temperature regulator can comprise a control unit. This control unit can be used to set a certain regime of temperature change during the course of the test, such that the actual temperature of bursting can be compared and even a response lag at various different regimes can be obtained.

In order to properly regulate the temperature of the air inside the chamber, the temperature regulator can comprise a air heater, such as a hot air gun. This air heater or hot air gun can be placed with its hot air outlet inside the chamber or can alternatively be an heating system inside the chamber.

Since these air heaters typically are provided with an electrically operated resistor type of heater, the amount of current through the resistor can be accurately regulated by the controller, as well as a forced airflow through or around the resistor type heating element by the use of a ventilator or the like. By these two parameters, the temperature inside the chamber can be very accurately and very homogenously be controlled, such that a highly accurate measurement of the activation temperature can be achieved.

The temperature regulator can comprise a camera and/or a bulb burst registration, e.g. an acoustic sensor. With a camera the actual moment of bursting can be captured as well as the functioning of the sprinkler head, e.g. the spray pattern or spray cone exiting the nozzle of the sprinkler head.

The control unit can be configured to provide a time dependant temperature profile in the chamber. This may be of importance for registering a delay at a specific heating regime. By having a relative quick rise in ambient air temperature, experienced by the sprinkler head, the activation delay may be monitored. Especially when several different heating regimes, whit varying rates of heating, a series of activation delays can be obtained, which can be compared with the design specifications of the system, in order to establish if the system is operating within its specifications.

The chamber of the test device can be mounted on a mobile lifting device, such as a fork lifter or a mobile crane. By this configuration, the test device can be positioned at high locations, where it may be difficult to reach without proper scaffolding or other means of access.

The invention further encompasses a method for testing a sprinkler system, comprising the following steps, to be executed in any suitable order; providing a sprinkler test device as described herein above; positioning the chamber of the sprinkler test device around a first sprinkler head of a sprinkler system to be tested; regulating the temperature around the sprinkler head for testing purposes.

By this method an elegant way of testing a sprinkler system is provided, that can measure and test the activation temperature of the specific sprinkler heads in question and test and measure the performance of the system in spray pattern and in volume flow of the extinguishing agent.

An auxiliary pump can be connected to the sprinkler system, before the actual testing of the sprinkler heads is started, wherein a permanently installed pump of the sprinkler system can be blocked off from its sprinkler heads. The advantage of using an alternative pump is that the volume flows can be reduced, and the pressure can be controlled, without changing the settings of the permanently installed pump. These permanently installed sprinkler system pump are typically high volume, high pressure pumps, whereas an auxiliary pump can provide a relative modest flow at a modest pressure. Thus, the amount of water exiting the sprinkler system during testing can be kept relatively small and the functionality of the system can be tested at relative low pressures, mimicking a situation where e.g. multiple spray heads are open. Once the flow data is collected, like the measured pressure and the measured flow, an extrapolation to the design specifications of the system can reliably be made.

In order to further elucidate the invention, exemplary embodiments will be described with reference to the figures. In the figures:

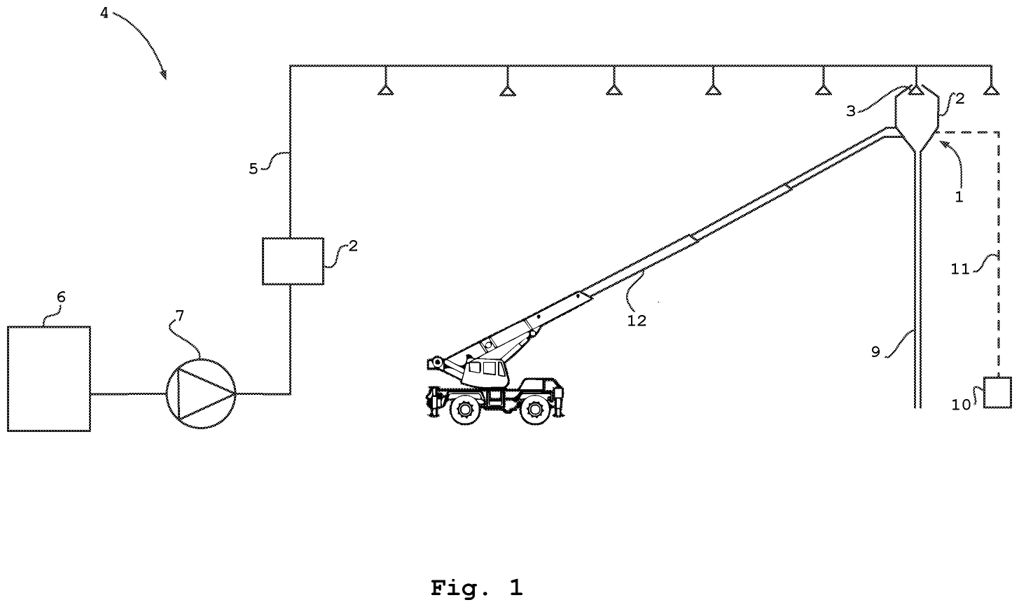

FIG. 1 depicts a first schematic view of a testing system according to a first embodiment of the invention;

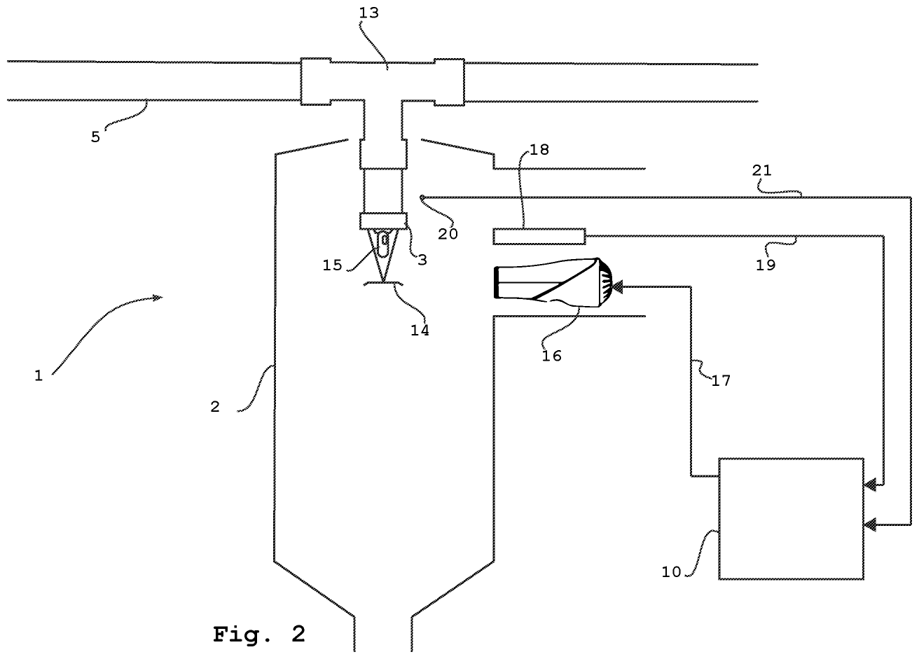

FIG. 2 depicts a schematic more detailed view of the system according to the embodiment of FIG. 1;

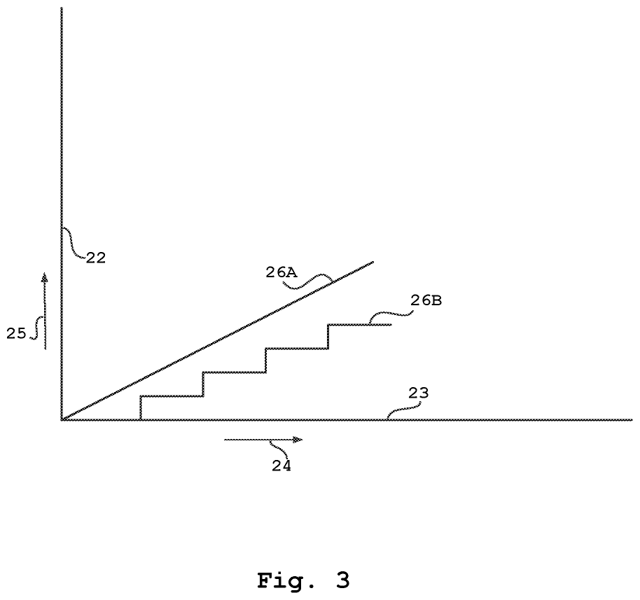

FIG. 3 depicts a schematic testing regime according to a further embodiment of the invention.

The figures represent specific exemplary embodiments of the inventions and should not be considered limiting the invention in any way or form. Throughout the description and the figures the same or corresponding reference numerals are used for the same or corresponding elements.

The expression “water” used herein is to be understood as, though not to be considered limited to water, but is referring to any suitable extinguishing agent, including water.

The expression “extinguishing agent” used herein is to be understood as, though not to be considered limited to any liquid or if so required foam or gaseous agent that is capable and suitable for extinguishing fires. The most commonly used extinguishing agent is water.

The expression “sprinkler head, spray head and spray nozzle” used herein are to be understood as, though not to be considered limited to those parts of the sprinkler system, where the water exits the system and is most of the time sprayed in the building space where a fire has occurred.

The expression “fuse” used herein are to be understood as, though not to be considered limited to any type of element that loses its physical integrity under a temperature rise, at a specific predetermined temperature such as a glass bulb, containing a liquid that starts to boil at a specific determined temperature, a specific alloy that melts at a predetermined temperature, or a set of parts hold together by such specific alloy.

In FIG. 1, a test device 1 is depicted comprising a chamber 2 which is positioned around and used on sprinkler head 3 of a sprinkler system 4. The Sprinkler system comprises a conduit 5 running from a water supply 6 to, amongst others, the sprinkler head 3. In the conduit 5, a pump 7 can be provided for urging the water towards the sprinkler heads and a water meter 8 for measuring the water flow. This flow meter can be for instance an induction flow meter.

From the chamber 2 of the test device 1, a hose 9 is running down towards a drain or a collection tank for inspecting and testing the actual outpouring flow from sprinkler head 3. A control unit 10 is connected through a power and control lines 11 to the chamber as is depicted in more detail in FIG. 2. The Chamber 2 of the testing device 1 can comprise a metal shell and can be mounted on a mobile lifting device 12, such as a fork lift or a mobile crane.

In FIG. 2 a detailed view of the testing device 1 is provided. Here the chamber 2 of the testing device 1 is positioned around the sprinkler head 3. The sprinkler head 3 is connected to the conduit 5 by means of a T-connector 13. The sprinkler head 3 typically comprises a deflector plate 14 and a fuse 15, which fuse holds in place a cap or stopper to seal of the exiting nozzle of the sprinkler head 1 as long as it is not activated.

The chamber 2 of the testing device 1 comprises in this embodiment a air heater 16, which can be a hot air gun or a hair drier. The air heater is powered and regulated by the controller 10 through the power and control line 17.

The chamber 2 further comprises a temperature sensor 20, which is connected to the controller by control line 21. The measured temperature can be used for regulating the temperature and for registering the temperature regime during a test. The chamber 2 can further comprise a camera 18 to inspect if the sprinkler 3 indeed is activated and provide a spraying pattern.

A typical test temperature regime is depicted in FIG. 3. In this figure the horizontal axis, the abscissa 23 represents time 24, and the vertical axis, the ordinate 22 represents the temperature 25. The line 26 represents the time dependent temperature regime that is used during a test.

The invention is to be understood not to be limited to the exemplary embodiments shown in the figures and described in the specification. For instance the top wall of the chamber 2 can be comprising a set of inwardly arranged brushes which allow to be fitted around a sprinkler head, yet seal off and isolate the inner part of the chamber 2 as much as possible from the ambient surroundings, while the sprinkler head is penetrating through the brushes.

Another way may be a resilient foil seal with a central hole and e.g. a resilient reinforcement ring around said hole, for fitting snuggly around the sprinkler head 3 to be tested.

The temperature control regulated by the sensor 20 controller 10 and the heater 16, used to regulate the temperature may alternatively comprise a small container, configured to fit around the sprinkler head, which container can be filled with a temperature controlled liquid, e.g. a bio-based oil such as vegetable oil or any other suitable liquid or oil. In this alternative, the oil in the container is slowly heated up, until the fuse will collapse. These and other modifications are considered to be variations that are part of the framework, the spirit and the scope of the invention outlined in the claims.

### LIST OF REFERENCE SIGNS

1. Test device
2. Chamber
3. Sprinkler head
4. Sprinkler system
5. Conduit
6. Water supply
7. Pump
8. Flow meter
9. Hose
10. Control unit
11. Control line
12. Mobile lifting device
13. T-connector
14. Deflector plate
15. Fuse
16. Air heater
17. Control and power line
18. Camera
19. Power and signal line
20. Temperature sensor
21. signal line
22. Ordinate
23. Abscissa
24. Arrow representing time
25. Arrow representing temperature
26. Line representing temperature regime

1. A sprinkler test device comprising:
a chamber configured to fit around a sprinkler head mounted in a sprinkler system;
a drain conduit for guiding extinguishing agent to a disposal or collection container; and
a temperature regulator for regulating the temperature in the chamber.

2. The sprinkler test device according to claim 1, wherein the temperature regulator comprises a temperature sensor, preferably in the chamber.

3. The sprinkler test device according to claim 1, wherein the temperature regulator comprises a control unit.

4. The sprinkler test device according to any preceding claims claim 1, wherein the temperature regulator comprises an air heater.

5. The sprinkler test device according to claim 1, wherein the temperature regulator comprises a camera, a bulb burst registration device, or combinations thereof.

6. The sprinkler test device according to claim 1, wherein the control unit is configured to provide a time dependent temperature profile in the chamber.

7. The sprinkler test device according to claim 1, wherein the chamber of the test device is mounted on a mobile lifting device.

8. A method for testing a sprinkler system, comprising the following steps, to be executed in any suitable order;
a. providing a sprinkler test device according to claim 1;
b. positioning the chamber of the sprinkler test device around a first sprinkler head of a sprinkler system to be tested; and
c. regulating the temperature around the sprinkler head for testing purposes.

9. The method according to claim 8, wherein an auxiliary pump is connected to the sprinkler system before step b and a permanently installed pump of the sprinkler system is blocked off from the sprinkler heads of the system.

10. The sprinkler test device according to claim 4, wherein the air heater comprises a hot air gun.

11. The sprinkler test device according to claim 5, wherein the bulb burst registration device is an acoustic sensor.

12. The sprinkler test device according to claim 7, wherein the mobile lifting device comprises a forklift or a mobile crane.
